(19) United States
(12) Patent Application Publication
(10) Pub. No.: US 2026/0145469 A1
(43) Pub. Date: May 28, 2026

(54) METHOD FOR ACQUIRING THE VALUE OF A VOLTAGE DROP ACROSS A POWER CELL OF A SENSOR OF A TYRE PRESSURE MONITORING SYSTEM, AND SENSOR FOR A TYRE PRESSURE MONITORING SYSTEM OF A MOTOR VEHICLE

(71) Applicant: Continental Automotive Technologies GmbH, Hannover (DE)

(72) Inventors: Aurélien MALARD, Toulouse (FR); Fabien DELEPLANQUE, Toulouse (FR); Vincent CHEVALLIER, Toulouse (FR)

(73) Assignee: Continental Automotive Technologies GmbH, Hannover (DE)

(21) Appl. No.: 19/121,208

(22) PCT Filed: Oct. 20, 2023
(86) PCT No.: PCT/EP2023/079271

§ 371 Date: Apr. 15, 2025

(30) Foreign Application Priority Data
Dec. 8, 2022 (FR) FR2212950

(51) Int. Cl. B60C 23/04

(52) U.S. Cl. CPC B60C 23/0481; B60C 23/041; B60C 23/0455

(57) ABSTRACT

A method for acquiring the value of a voltage drop of a power supply battery of a sensor of a tire pressure monitoring system. The sensor includes an ultra-high-frequency two-way communicator. The method includes the steps of: acquiring the load voltage of the battery when the sensor transmits data; computing the voltage drop based on the load voltage; and transmitting the voltage drop. Also disclosed is a sensor for a tire pressure monitoring system.

### CROSS REFERENCE TO RELATED APPLICATIONS

This application is the U.S. National Phase Application of PCT International Application No. PCT/EP2023/079271, filed Oct. 20, 2023, which claims priority to French Patent Application No. FR2212950, filed Dec. 8, 2022, the contents of such applications being incorporated by reference herein.

### FIELD OF THE INVENTION

The present invention relates to a method for acquiring the value of a voltage drop of a power supply battery of a sensor of a tire pressure monitoring system.

The invention also relates to a sensor for a tire pressure monitoring system of a motor vehicle.

### BACKGROUND OF THE INVENTION

For safety purposes, it is known practice for a motor vehicle to be equipped with a tire pressure monitoring system for the motor vehicle.

A system with a set of sensors, called “WFC” (“Wheel Fitted Component”) system, performs measurements carried out by various sensors of the motor vehicle.

These sensors can be, for example, a tire inflation pressure sensor, a temperature sensor, or a wheel acceleration sensor.

These measurements are transmitted to a central computing unit comprising an electronic computer called ECU (Electronic Control Unit).

The communication between the WFC system and the ECU is performed via a radio frequency communication network comprising transceivers.

The set of implemented means (sensors of the WFC system, central unit, communication network) forms the system conventionally known as the tire pressure monitoring system (TPMS).

The tire pressure sensors are typically powered by a non-rechargeable battery.

When producing the tire pressure sensors, a set of tests is performed in order to ensure that the produced parts comply with given specifications, in order to detect any faults in the manufacture or the behavior of the sensors.

To this end, a radio frequency frame, generally called “RF_DIAGNOSIS” or “RF frame”, is transmitted by the WFC system in order to verify that certain essential parameters of the wheel are correct.

The RF frame provides a set of fields for ensuring that there are no errors, in particular on the pressure sensor.

Among these fields, a field called “V_{drop}” (for voltage drop) computes the difference between the voltage of the no-load battery, namely, the voltage obtained when the sensor is at rest (for example, when it does not transmit an RF frame), and the voltage of the battery when the sensor is loaded, i.e., when the sensor is transmitting.

The obtained V_{drop} field is then compared with a predetermined threshold. This threshold notably varies as a function of the transmission frequencies of the pressure sensor, with the sensor not consuming the same transmission current as a function of its transmission frequency.

In a known manner, the pressure sensor transmits one-way links at frequencies of 433 MHz or 315 MHz.

Thus, the retained threshold value will not be the same depending on whether the pressure sensor transmits at the frequency of 433 MHz or whether it transmits at the frequency of 315 MHz (difference of a few tens to a few hundred millivolts).

In order to reduce manufacturing costs and to simplify the method for manufacturing pressure sensors, the pressure sensors can, in a known manner, communicate via ultra-high-frequency radio waves, for example, as per the Bluetooth® standard.

Such sensors then transmit two-way links at a frequency of the order of 2.4 GHz.

The compatible components of the Bluetooth® standard currently on the market are not specifically designed for TPMSs.

Thus, their architecture does not natively integrate the possibility of measuring the battery voltage when the sensor is loaded, i.e., when the sensor transmits over the 2.4 GHz frequency.

Thus, the voltage drop of the power supply battery of the sensor cannot be determined according to the usual method known in the art when the sensors of the TPMS dialogue over an ultra-high-frequency two-way communication protocol, such as per the Bluetooth® standard.

### SUMMARY OF THE INVENTION

An aspect of the present invention aims to overcome the disadvantages of the prior art, and, to this end, relates to a method for acquiring the value of a voltage drop of a power supply battery of a sensor of a tire pressure monitoring system, said sensor being designed to detect an anomaly in a wheel unit of a motor vehicle and comprising an ultra-high-frequency two-way communication means, for example, as per the Bluetooth® standard, said method being noteworthy in that it comprises the following steps of:
acquiring the load voltage of said power supply battery when said sensor transmits data;
computing the voltage drop based on said acquired load voltage;
transmitting said computed voltage drop.

Thus, by virtue of an aspect of the present invention, the value of the voltage drop of the power supply battery of a sensor of a tire pressure monitoring system can be acquired when the system sensor transmits according to an ultra-high-frequency two-way mode, such as per the Bluetooth® standard.

The method obtained according to an aspect of the present invention can be used, for example, to detect certain manufacturing faults, certain breakdowns or certain defective behaviors of the sensors of the tire pressure monitoring system.

Furthermore, making the method according to an aspect of the invention compatible with use in a sensor of the tire pressure monitoring system communicating in an ultra-high-frequency two-way mode, for example, as per the Bluetooth® standard, advantageously allows certain manufacturing faults, certain breakdowns or certain defective behaviors of the sensors to be detected that would not be able to be detected with a sensor that communicates in a low frequency one-way mode (notably 433 MHz or 315 MHz).

According to optional features of the method according to an aspect of the invention:
the step of acquiring the load voltage of said power supply battery when said sensor transmits data is performed on a first transmission frame and the step of transmitting said computed voltage drop is performed on a second transmission frame following said first transmission frame;
the step of acquiring the load voltage of said power supply battery when said sensor transmits data is performed on a first transmission frequency set comprising at least one transmission channel and the step of transmitting said computed voltage drop is performed on a second transmission frequency set of said sensor, comprising at least one transmission channel and being distinct from said first transmission frequency set used to carry out said acquisition step;
said first transmission frequency set comprises three transmission channels and said second transmission frequency set comprises a single transmission channel;
the step of acquiring the load voltage of said power supply battery when said sensor transmits data is performed on each of said transmission channels and the transmission power of at least one of said transmission channels of said first transmission frequency set is different from the transmission power of the other transmission channels of said first transmission frequency set;
the step of acquiring the load voltage of said power supply battery when said sensor transmits data and the step of transmitting said computed voltage drop are performed on the same first transmission frame;
the step of acquiring the load voltage of said power supply battery when said sensor transmits data is performed on a first transmission frequency set comprising at least one transmission channel and the step of transmitting said computed voltage drop is performed on a second transmission frequency set of said sensor, comprising at least one transmission channel and being distinct from said first transmission frequency set used to carry out said acquisition step;
said first transmission frequency set comprises a single transmission channel and said second transmission frequency set comprises two transmission channels following said single transmission channel of said first transmission frequency set;
said first transmission frequency set comprises two transmission channels and said second transmission frequency set comprises a single transmission channel following said transmission channels of said first transmission frequency set;
the step of computing the voltage drop based on said acquired load voltage is carried out by measuring a no-load voltage of said power supply battery.

An aspect of the invention also relates to a sensor for a tire pressure monitoring system of a motor vehicle, noteworthy in that it comprises hardware and/or software means for implementing the method according to an aspect of the invention.

### BRIEF DESCRIPTION OF THE DRAWINGS

Further features, aims and advantages of aspects of the invention will become apparent upon reading the following detailed description, which can be understood with reference to the appended drawings, in which:

FIG. 1 is a schematic view of a motor vehicle according to an aspect of the invention;

FIG. 2 lists the steps of the method for acquiring the value of a voltage drop of the power supply battery of the sensor of the tire pressure monitoring system, obtained according to an aspect of the invention;

FIG. 3 illustrates a first embodiment of the method according to the invention;

FIG. 4 illustrates a second embodiment of the method according to the invention;

FIG. 5 illustrates a third embodiment of the method according to the invention;

FIG. 6 illustrates an alternative embodiment of the third embodiment of the method according to the invention.

### DETAILED DESCRIPTION OF EXEMPLARY EMBODIMENTS

Throughout the remainder of the description, elements with an identical structure or similar functions are designated using the same reference.

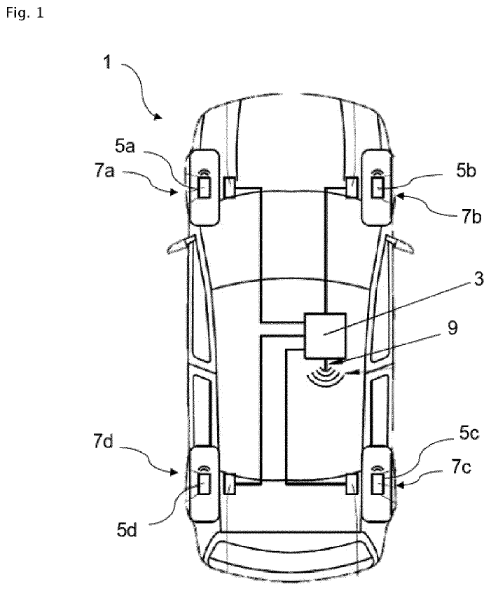

Reference is made to FIG. 1, which illustrates a motor vehicle 1 according to an aspect of the invention.

The motor vehicle is equipped with a central computing unit 3, comprising, for example, an electronic computer, referred to as an “Electronic Control Unit” (ECU), and a memory.

The motor vehicle further comprises four wheel units 5a, 5b, 5c, 5d, which are each mounted on an associated wheel 7a, 7b, 7c, 7d, and at least one communication device 9 allowing two-way exchanges of messages, or signals, between the central unit 3 and each wheel unit 5a, 5b, 5c, 5d.

Each wheel unit 5a, 5b, 5c, 5d comprises an electronic housing that contains a set of sensors (not shown), notably intended for measuring parameters such as the pressure and the temperature of the tire fitted to the associated wheel and designed to detect an anomaly in the corresponding wheel unit.

The communication with the sensors of the TPMS occurs in accordance with a communication protocol allowing short-range two-way exchanges of data using ultra-high-frequency (UHF) radio waves, for example, as per the Bluetooth® standard.

The sensors of the TPMS thus comprise an ultra-high-frequency two-way radio frequency communication means as per the Bluetooth® standard.

The sensors of each wheel unit define a system called “WFC” (“Wheel Fitted Component”) system.

The set comprising the sensors of the WFC system, the central unit and the communication device form a system conventionally known as a tire pressure monitoring system (TPMS).

The sensors of the TPMS, in particular the tire pressure sensors, are typically powered by a non-rechargeable power supply battery.

The power supply battery can be, for example, a 3 Volt lithium button battery, for example, of the CR2032 type.

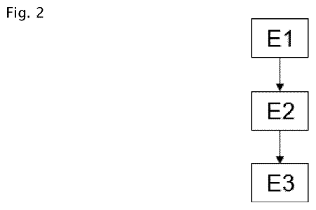

Reference is made to FIG. 2, which illustrates the steps of the method for acquiring the value of a voltage drop of the power supply battery of the sensor of the tire pressure monitoring system, obtained according to an aspect of the invention.

In one embodiment of the invention, the method according to the invention is initiated when producing the sensors of the TPMS in order to monitor whether the produced sensors meet the requirements of specifications.

To this end, the sensors of the TPMS comprise hardware and/or software means adapted to implement the method of an aspect of the invention.

The software means notably can include computer program code means, notably comprising an algorithm designed for carrying out the steps of the method according to an aspect of the invention.

The method according to an aspect of the invention comprises a first step E1 of acquiring the load voltage V_{load} of the power supply battery of the sensor to be monitored.

The load voltage V_{load} is the voltage of the battery when the sensor transmits data.

Such data transmission occurs when the sensor transmits a radio frequency frame, for example, a frame called “RF_DIAGNOSIS” or “RF frame”.

When an RF frame is transmitted, the battery consumes a certain amount of energy, and consequently current. This consumption drops the voltage of the sensor battery that is monitored, for example, from a few ten to a few hundred millivolts. Thus, the load voltage V_{load} is thus lower than a no-load voltage V_{no-load} of the battery, which voltage is observed when the sensor is at rest, i.e., when the sensor does not transmit.

The acquisition step E1 is performed on one or more transmission channels of the sensor, as will be seen in the remainder of the description.

Based on the value of the load voltage V_{load} thus acquired, the method of an aspect of the invention comprises a second step E2, during which the voltage drop V_{drop} is computed based on said acquired load voltage V_{load}.

The value of the voltage drop V_{drop} is obtained using the following formula:

$${V}_{drop} = {V}_{no - load} - {V}_{load}$$

where:
V_{drop} is the voltage drop of the battery;
V_{no-load} is the no-load voltage of the battery;
V_{load} is the voltage of the loaded battery.

According to a first alternative embodiment of the method according to the invention, the no-load voltage V_{no-load} of the battery used for computing the voltage drop V_{drop} is equal to that stipulated by the battery manufacturer. The no-load voltage V_{no-load} of the battery is thus theoretical.

Thus, only the measurement of the load voltage V_{load} of the battery is measured in order to deduce the voltage drop V_{drop} therefrom.

According to a second alternative embodiment of the method according to the invention, the no-load voltage V_{no-load} of the battery used for computing the voltage drop V_{drop} is obtained by measuring the no-load voltage of the battery, i.e., when the sensor is at rest, for example, when it does not transmit an RF frame.

This measurement is carried out, for example, before measuring the load voltage V_{load} of the battery.

The no-load voltage V_{no-load} of the battery in this case is real and allows the wear factor of the battery to be taken into account. Indeed, over time, the no-load voltage V_{no-load} of the battery can decrease by a few ten or a few hundred millivolts compared to its original value stipulated by the battery manufacturer.

Thus, by virtue of this second alternative embodiment, the computation of the voltage drop V_{drop} is thus refined compared to the first alternative embodiment.

The voltage drop V_{drop} can be computed via a software or physical installation known to a person skilled in the art.

According to a third step E3 of the method according to an aspect of the invention, the method comprises a step of transmitting the voltage drop V_{drop} computed during step E2.

The transmission step E3 is implemented on one or more transmission channels of the sensor that are distinct from the one or more transmission channels used to carry out the acquisition step E1, as will be seen in the remainder of the description.

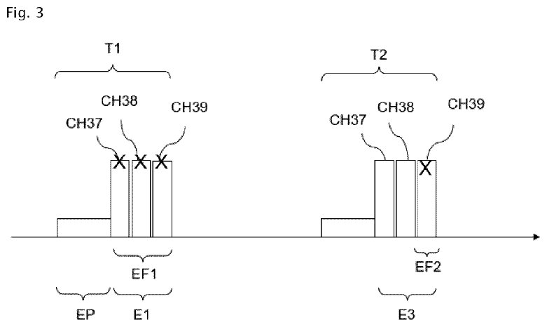

Reference is made to FIG. 3, which shows a first embodiment of the method according to the invention.

In this first embodiment, the step E1 of acquiring the load voltage V_{load} is performed on a first transmission frame T1 of the sensor and the step E3 of transmitting the computed voltage drop V_{drop} is performed on a second transmission frame T2 of the sensor, temporally following the transmission frame T1.

According to the current Bluetooth® standard, each transmission frame of the sensor comprises three transmission channels CH37, CH38, CH39, respectively transmitting at frequencies of 2402 MHz, 2426 MHz and 2480 MHz.

The step E1 of acquiring the load voltage V_{load} implemented on the first transmission frame T1 is performed, for example, on each transmission channel CH37, CH38, CH39 of the first transmission frame T1.

When the channels CH37, CH38, CH39 of the transmission frame T1 have stopped transmitting, the step E1 of acquiring the load voltage V_{load} is stopped and the step E2 of computing the voltage drop V_{drop} based on the acquired load voltage V_{load} is initiated.

In order to perform the step E2 of computing the voltage drop V_{drop}, the no-load voltage V_{no-load} of the battery can be equal to that stipulated by the battery manufacturer or it can be measured before measuring the load voltage V_{load} of the battery (prior step designated by reference “EP” indicated in FIG. 3).

With the sensor having finished transmitting on the transmission frame T1, the step E3 of transmitting the voltage drop V_{drop} thus computed is carried out when the next transmission frame T2 is transmitted.

The step E3 of transmitting the voltage drop V_{drop} implemented on the second transmission frame T2 is performed, for example, on the transmission channel CH39 of the second transmission frame T2.

The second transmission frame T2, on which the step E3 of transmitting the voltage drop V_{drop} is implemented, directly follows the first transmission frame T1, for example.

In the embodiment provided, the transmission channels CH37, CH38 and CH39 of the first transmission frame T1, on which the sensor performs the step E1 of acquiring the load voltage V_{load}, define a first transmission frequency set EF1 belonging to the first transmission frame T1.

As a variant, the first transmission frequency set EF1 can be defined by only one of the channels CH37, CH38, CH39 of the first transmission frame T1 or two of the channels CH37, CH38, CH39 of the first transmission frame T1.

Similarly, in the embodiment provided, the transmission channel CH39 of the second transmission frame T2, on which the sensor performs the step E3 of transmitting the voltage drop V_{drop}, defines a second transmission frequency set EF2 distinct from the first transmission frequency set EF1 used to carry out the acquisition step.

As a variant, the second transmission frequency set EF2 can be defined by another transmission channel of the second transmission frame T2 (channel CH37 or channel CH38) or can be defined by several channels CH37, CH38, CH39 of the second transmission frame T2.

In this first embodiment, the value of the voltage drop V_{drop} computed based on the data acquired when transmitting a transmission frame N is then transmitted when transmitting a transmission frame N+1.

In this way, the value of the voltage drop V_{drop} can be provided to the nearest transmission.

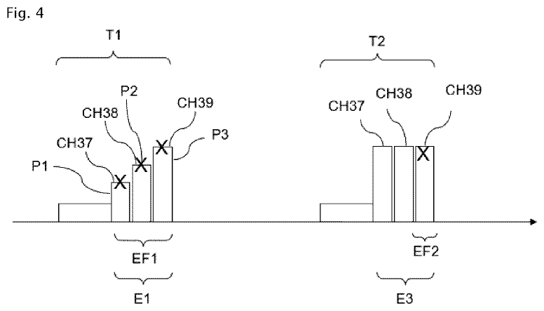

Reference is made to FIG. 4, which shows a second embodiment of the method according to the invention.

In this second embodiment, the measurement of the load voltage V_{load} is performed several times by configuring the transmission power of the sensor on one or more of the transmission channels CH37, CH38, CH39 of the same transmission frame T1.

Thus, the step E1 of acquiring the load voltage V_{load} implemented on the first transmission frame T1 is performed, for example, on each transmission channel CH37, CH38, CH39 of the first transmission frame T1 and the transmission power can vary from one transmission channel to the next.

In the example illustrated in FIG. 4, the power P1 of the channel CH37 of the frame T1 is lower than the power P2 of the channel CH38, which itself is lower than the power P3 of the channel CH39.

For example, the power P1 of the channel CH37 can be equal to −2 dBm, the power P2 can be equal to 0 dBm and the power P3 can be equal to +2 dBm.

As a variant, the power P3 can be lower than the power P2, which itself is lower than the power P1. Furthermore, the power P1 can be higher than the power P3, which itself is higher than the power P2.

As for the first embodiment, the step E3 of transmitting the computed voltage drop V_{drop} based on the data acquired when transmitting the channels of the transmission frame T1 is performed on the second transmission frame T2 of the sensor, following the transmission frame T1.

In the embodiment provided, the transmission channel CH39 of the second transmission frame T2, on which the sensor performs the step E3 of transmitting the voltage drop V_{drop}, defines a second transmission frequency set EF2 distinct from the first transmission frequency set EF1 used to carry out the acquisition step.

As a variant, the second transmission frequency set EF2 can be defined by another transmission channel of the second transmission frame T2 (channel CH37 or channel CH38) or can be defined by several channels CH37, CH38, CH39 of the second transmission frame T2.

By varying the transmission power, some faults in the sensor can be deduced. Notably, it is possible to detect an absence of electronic components, notably the “matching” components present between an electrical circuit and a transmission antenna.

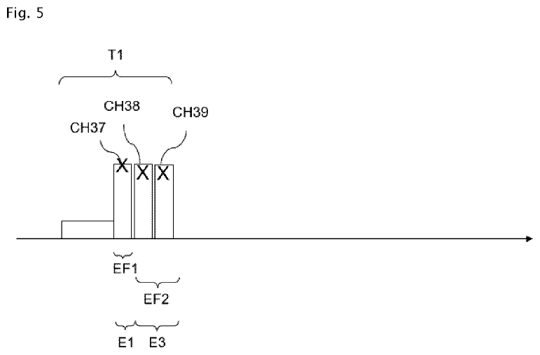

Reference is made to FIG. 5, which shows a third embodiment of the method according to the invention.

In this third embodiment, the step E1 of acquiring the load voltage V_{load} and the step of transmitting the computed voltage drop V_{drop} are performed on the same transmission frame T1.

To this end, the step E1 of acquiring the load voltage V_{load} is performed on a first transmission frequency set EF1 comprising a single transmission channel CH37, while the step E3 of transmitting the computed voltage drop V_{drop} is performed on a second transmission frequency set EF2 comprising two transmission channels CH38, CH39 following the single transmission channel CH37 of the first transmission frequency set EF1.

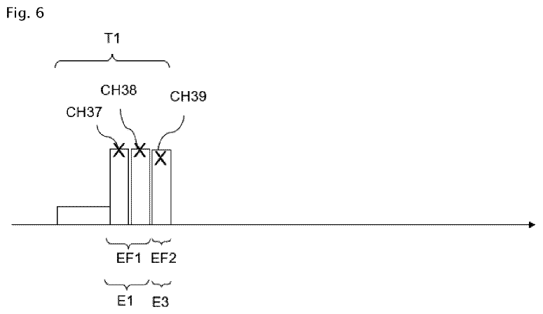

According to an alternative embodiment shown in FIG. 6, the step E1 of acquiring the load voltage V_{load} is performed on a first transmission frequency set EF1 comprising two transmission channels CH37, CH38, while the step E3 of transmitting the computed voltage drop V_{drop} is performed on a second transmission frequency set EF2 comprising a single transmission channel CH39 following the transmission channels CH37, CH38 of the first transmission frequency set EF1.

Thus, according to this third embodiment, the transmission time and therefore the cycle time are reduced compared to the first and second embodiments, irrespective of the variant that is used (namely, that illustrated in FIG. 5 or that illustrated in FIG. 6).

Indeed, it is no longer necessary to wait for the transmission of the second transmission frame T2 in order to transmit the value of the computed voltage drop V_{drop} on the second transmission frequency set EF2 of the first transmission frame T1.

In other words, the value of the voltage drop V_{drop} is transmitted on the same transmission frame T1 as that used to measure the load voltage V_{load}, but on a different transmission frequency set from that used to measure the load voltage V_{load}.

In one embodiment of the invention, the method according to the invention is initiated when producing the sensors of the TPMS.

The method according to an aspect of the invention can be used in order to detect certain manufacturing faults, breakdowns or defective behavior of the sensors.

Furthermore, making the method according to an aspect of the invention compatible with use in a sensor of the tire pressure monitoring system communicating in an ultra-high-frequency two-way mode, such as, for example, as per the Bluetooth® standard, advantageously allows certain manufacturing faults, certain breakdowns or certain defective behaviors of the sensors to be detected that it would not have been possible to detect with a sensor that communicates according to a low frequency one-way mode (notably 433 MHz or 315 MHz).

By way of non-limiting examples, the method of an aspect of the invention can be used for:
detecting a batch of faulty power supply batteries (with off-specification internal resistance);
detecting batteries stored for too long, for example, due to factory closure, bad weather, a pandemic, etc.;
deducing that certain finished products have been stored for too long;
detecting the absence of electronic components, notably the “matching” components present between an electrical circuit and a transmission antenna. Their absence causes the current to increase when transmitting a frame, resulting in an out-of-limit voltage drop value V_{drop};
detecting incorrect values of certain “matching” electronic components;
detecting the presence of an incorrect weld on the transmission antenna or on other components;
detecting a non-compliance in the transmission antenna;
detecting an unforeseen on-line coupling effect with metal parts and resulting in electrical overconsumption of the power supply battery;
detecting a consumption fault of the chipset resulting in a risk of decreasing the service life of the finished product, or in premature deterioration of the power supply battery.

The method according to an aspect of the present invention can be particularly applied to the pressure sensors of the TPMS of the motor vehicle. However, the method can be applied to all the sensors of the TPMS that are powered by a power supply battery.

Of course, the present invention is not limited to only the embodiments of this method for acquiring the value of a voltage drop of a power supply battery of a sensor of a tire pressure monitoring system and of this sensor for a tire pressure monitoring system of a motor vehicle, which are described above solely by way of illustrative examples, but, on the contrary, it encompasses any variants involving the technical equivalents of the described means, as well as their combinations if these fall within the scope of the invention.

1. A method for acquiring the value of a voltage drop of a power supply battery of a sensor of a tire pressure monitoring system, said sensor being designed to detect an anomaly in a wheel unit of a motor vehicle and comprising an ultra-high-frequency two-way communication means, said method comprising:
acquiring the load voltage of said power supply battery when said sensor transmits data;
computing the voltage drop based on said acquired load voltage; and
transmitting said computed voltage drop.

2. The method as claimed in claim 1, wherein the step of acquiring the load voltage of said power supply battery when said sensor transmits data is performed on a first transmission frame and the step of transmitting said computed voltage drop is performed on a second transmission frame following said first transmission frame.

3. The method as claimed in claim 2, wherein:
the step of acquiring the load voltage of said power supply battery when said sensor transmits data is performed on a first transmission frequency set comprising at least one transmission channel;
the step of transmitting said computed voltage drop is performed on a second transmission frequency set of said sensor, comprising at least one transmission channel and being distinct from said first transmission frequency set used to carry out said acquisition step.

4. The method as claimed in claim 3, wherein said first transmission frequency set comprises three transmission channels and wherein said second transmission frequency set comprises a single transmission channel.

5. The method as claimed in claim 3, wherein the step of acquiring the load voltage of said power supply battery when said sensor transmits data is performed on each of said transmission channels and in that wherein the transmission power of at least one of said transmission channels of said first transmission frequency set is different from the transmission power of the other transmission channels of said first transmission frequency set.

6. The method as claimed in claim 1, wherein the step of acquiring the load voltage of said power supply battery when said sensor transmits data and the step of transmitting said computed voltage drop are performed on the same first transmission frame.

7. The method as claimed in claim 6, wherein:
the step of acquiring the load voltage of said power supply battery when said sensor transmits data is performed on a first transmission frequency set comprising at least one transmission channel;
the step of transmitting said computed voltage drop is performed on a second transmission frequency set of said sensor, comprising at least one transmission channel and being distinct from said first transmission frequency set used to carry out said acquisition step.

8. The method as claimed in claim 7, wherein said first transmission frequency set comprises a single transmission channel and wherein said second transmission frequency set comprises two transmission channels following said single transmission channel of said first transmission frequency set.

9. The method as claimed in claim 7, wherein said first transmission frequency set comprises two transmission channels and wherein said second transmission frequency set comprises a single transmission channel following said transmission channels of said first transmission frequency set.

10. The method as claimed in claim 1, wherein the step of computing the voltage drop based on said acquired load voltage is carried out by measuring a no-load voltage of said power supply battery.

11. A sensor for a tire pressure monitoring system of a motor vehicle, wherein it comprises hardware and/or software means for implementing the method as claimed in claim 1.

12. The method as claimed in claim 4, wherein the step of acquiring the load voltage of said power supply battery when said sensor transmits data is performed on each of said transmission channels and wherein the transmission power of at least one of said transmission channels of said first transmission frequency set is different from the transmission power of the other transmission channels of said first transmission frequency set.
